(19) United States
(12) Patent Application Publication
(10) Pub. No.: US 2026/0209128 A1
(43) Pub. Date: Jul. 23, 2026

(54) METHODS, SYSTEMS, AND DEVICES FOR MANUFACTURING CERAMIC COMPOSITES

(71) Applicant: CARBON SIC TECHNOLOGIES, INC., Henderson, NV (US)

(72) Inventor: Clifford B. Leonard, Las Vegas, NV (US)

(21) Appl. No.: 19/141,840

(22) PCT Filed: Dec. 22, 2023
(86) PCT No.: PCT/US2023/085673

§ 371 Date: Jun. 20, 2025

Related U.S. Application Data
(60) Provisional application No. 63/434,592, filed on Dec. 22, 2022.

(51) Int. Cl. C04B 35/80; C04B 35/64

(52) U.S. Cl. CPC C04B 35/80; C04B 35/64; C04B 2235/5248; C04B 2235/658; C04B 2235/666

(57) ABSTRACT

System, apparatuses, and methods for manufacturing ceramic composite using spark plasma sintering are provided. In many embodiments, raw materials are mixed and placed into a spark plasma sintering machine and heated to a target temperature by conducting electricity through a mold. Pressure is applied to the materials during the process to create a densified part. Subsequently, the densified part can be removed from the spark plasma sintering machine.

### FIELD

The subject matter described herein relates generally to methods, systems, and devices for manufacturing ceramic composites. In particular, disclosed herein are various embodiments of methods, systems, and devices that utilize spark plasma sintering for the manufacture of carbon fiber reinforced ceramic composites.

### BACKGROUND

Carbon fiber reinforced silicon carbide (SiC), and ceramic composites in general, have a plethora of uses in automotive, defense, and aerospace applications, to name only a few, because of their strong oxidation resistance, thermal properties, corrosive resistance, and excellent friction properties. A few examples include brake rotors, rocket nozzles, and hypersonic vehicles and missiles, to name only a few.

Despite the wide array of applications, manufacturing composites can be challenging. Generally, ceramic composite materials can be manufactured utilizing high-temperature or ultra-high temperature methods of varying production times and cost. Some methods for manufacturing ceramic composite materials can include, for example, supplementing the ceramic phases with reinforcement elements, such as short fibers (also known as discontinuous fibers) and continuous fibers. Composite materials can further be produced by infiltrating carbon pre-forms with suspensions (e.g., slurries) of various ultra-refractory ceramics. Many of these processes employ chemical vapor infiltration (CVI) techniques, primarily with carbon vapors, in order to close open pores and favor the in situ formation of a silicon carbide phase in the boride matrix. The densification of the material is generally carried out by means of repeated polymer infiltration and pyrolysis (PIP) cycles. However, the infiltration and densification of the material using these processes have limits, including high costs and lengthy production times. Thus, improved systems, devices, and methods for the manufacture of carbon fiber reinforced ceramic composites are needed.

### SUMMARY

To improve upon the production times and costs in the manufacture of carbon fiber reinforced ceramic composites, many of the embodiments described herein include processes that utilize spark plasma sintering (SPS), sometimes also referred to as field assisted sintering technology (FAST) or direct current sintering (DCS). According to an aspect of the embodiments, SPS utilizes high electrical current to rapidly heat a conductive tooling assembly under simultaneous uniaxial pressure inside of a vacuum chamber. With no heating elements in the conductive tooling assembly, extremely rapid heating and cooling of the sample is possible, enabling high density materials to be sintered with ultra-fine, or even nano-sized grain structures. Zirconium diboride (ZrB2), in particular, has a high thermal conductivity, extremely high melting point of 3246° C. (5874.8° F), and self-healing properties when combined with SiC, making it desirable in structures such as brakes and hypersonic applications. When ZrB2 with SiC oxidizes, it turns into Zirconium dioxide and Silicon Dioxide, which forms borosilicate, a glass like layer over cracks and fractures. The layer also further protects the body from further oxidation by adding more resistance.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes, and other detailed attributes may be depicted schematically rather than literally or precisely.

FIG. 1 is a system overview of a spark plasma sintering system (SPS) for manufacturing carbon fiber reinforced ceramic composites.

FIG. 2. is a perspective view of components for use in an SPS system for manufacturing carbon fiber reinforced ceramic composites.

FIGS. 3A and 3B are exploded and perspective views, respectively, of components for use in an SPS system for manufacturing carbon fiber reinforced ceramic composites.

FIG. 4 is a flow diagram of a method for manufacturing carbon fiber reinforced ceramic composites using spark plasma sintering.

### DETAILED DESCRIPTION

Provided herein are example embodiments of systems, devices, and methods for the manufacture of carbon fiber reinforced ceramic composites using spark plasma sintering.

Before describing the methods in greater detail, it is worthwhile to describe example embodiments of systems and devices with which the subject matter can be implemented.

### Example Embodiments of Systems for Manufacturing Ceramic Composites

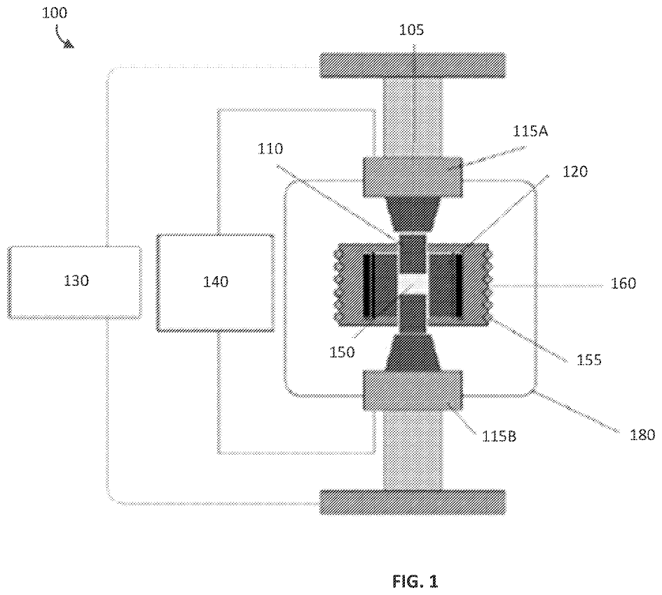

FIG. 1 is a conceptual diagram depicting an example embodiment of a system 100 for manufacturing carbon fiber reinforced ceramic composites using spark plasma sintering (SPS).

According to one aspect of the embodiments, SPS system 100 can comprise electrodes 115A and 115B configured to conduct electricity through a mold 120. In some embodiments, mold 120 can comprise a graphite material. Other materials can be utilized, as further described below. In many embodiments, electrodes 115A and 115B are configured to create an electrical current 140 therebetween. In some embodiments, electrical current 140 can be a pulsed DC current. In addition, according to many embodiments, SPS system 100 can further comprise a plurality of pistons 110 for applying force to sample 150 contained in mold 120. In some embodiments, pistons 110 can be powered through a hydraulic group 130.

Referring still to FIG. 1, according to another aspect of some embodiments, SPS system 100 can comprise a vacuum chamber 180. In some embodiments, SPS system 100 can optionally include a heating coil 155 near or around mold 120. In many embodiments, the temperature of SPS system 100 can be measured at various locations using temperature sensors 105 and 160. In some embodiments, temperature sensors 105 and 160 can comprise, for example, thermocouples and/or pyrometers.

### Example Embodiments of Tools and Tooling Parts for Manufacturing Ceramic Composites

Example embodiments of tools and tooling parts for the manufacture of ceramic composites, such as carbon fiber reinforced ceramic composites, will now be described. In some embodiments, tooling material can include graphite, tungsten carbide, silicon carbide, carbon fiber reinforced carbon, carbon fiber reinforced silicon carbide, to name only a few. In many embodiments, a carbon fiber mold with a relatively low coefficient of thermal expansion is preferably used. Said mold can also have a predetermined electrical resistivity. Depending on the placement of the tooling in the SPS chamber, stacking tools can also have predetermined electrically resistive characteristics in order to achieve the desired heating process. According to one aspect of the embodiments, the electric resistivity of a tool can change how electricity flows through the SPS system to heat up the component parts. According to some embodiments, to maintain a steady heating rate throughout the SPS system, a part closer to an electrode can have a higher resistivity than the tools located towards the center of the SPS chamber. Likewise, selecting for the predetermined resistivity of the dies can also take into consideration the raw material's electrical properties. Improper resistivity to raw material matching can result in either the inability to heat up raw material to the desired temperature, or overheating the dies such that components in the SPS system become susceptible to overheating from the thermal radiation given off from the other parts (specifically the ram emitting electrodes). This can result in a shutdown of the SPS system's equipment.

For example, if a component part's resistivity is too low, then electricity flows through it more freely, and, consequently, the part will not heat up as much. By contrast, when the part is more resistive to electricity, it will heat up more quickly. However, when too much electricity is passing through the part and not heating up the part, the SPS system can be configured to increase the output of electricity. This increase can heat the part up, but can also cause other components to heat up that should not be heated up, such as the ram attached to the electrode. Overheating other components can trigger safety mechanisms leading to an undesired shutdown of the SPS system's equipment.

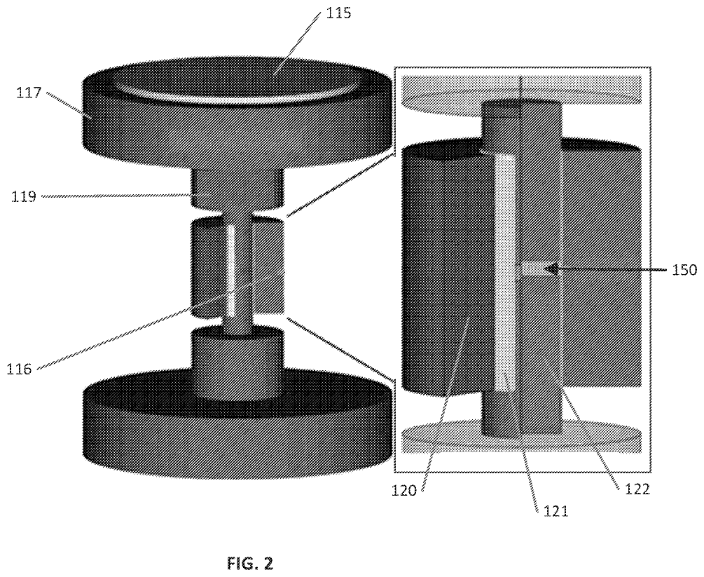

FIG. 2 is a perspective view of various example embodiments of components for use in an SPS system, such as SPS system 100 described with respect to FIG. 1, for the manufacture of carbon fiber reinforced ceramic composites. According to one aspect of the embodiments, components of the SPS system can include one or more electrodes 115, which can be made of an electrically conductive material, such as molybdenum (Mo). In addition, in many embodiments, a plurality of spacers 117 and 119 are implemented between the one or more electrodes 115 and sample 150. As shown in FIG. 2, in many embodiments, the plurality of spacers 117 and 119 can each comprise a different geometry and a predetermined electrical resistivity. In some embodiments, spacers 117 and 119 can each have the same or similar geometry and predetermined electrical resistivity. According to many embodiments, components of the SPS system can further comprise a die 120, which can be made of graphite or other materials described above. In many embodiments, die 120 can be lined with a foil 121, to facilitate removal of the sample 150 after the SPS process has completed. In addition, components can include one or more punches 122 to facilitate the application of axial force to sample 150 during the SPS process. As with die 120, the one or more punches 122 can comprise steel, graphite, or other materials, as described above.

According to another aspect of some embodiments, the temperature of various components described above and sample 150, can be monitored during the SPS process at one or more temperature measurement points 116. In many embodiments, the temperature of the one or more temperature measurement points 116 can be measured using a pyrometer and/or thermocouple, as described with respect to SPS system 100 of FIG. 1.

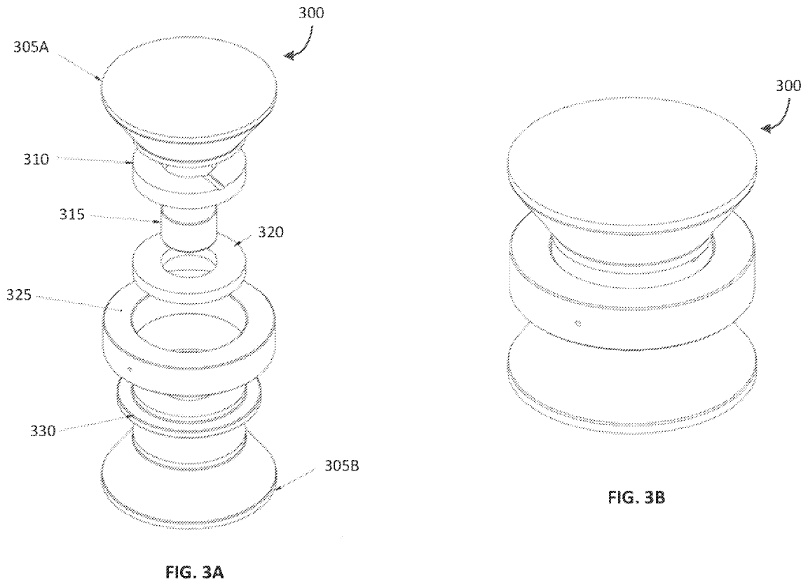

FIGS. 3A and 3B are exploded and perspective views, respectively, of example embodiments of components for use in an SPS system for the manufacture of carbon fiber reinforced ceramic composites. In particular, FIGS. 3A and 3B depict a die assembly 300, which can include concentration spacers 305A and 305B. According to many embodiments, concentration spacers 305A and 305B can have a frustoconical or partially frustoconical geometry that is configured to facilitate the conductivity of electricity to the components disposed therebetween. In another aspect of the embodiments, die assembly 300 can further include a top core structure 310, a bottom core structure 330, a center core post structure 315, and the sample 320, which is shown in a ring configuration with center core post structure 315 disposed in the center of sample 320. According to many embodiments, die assembly 300 further comprises an outer core structure 325 that surrounds top core structure 310, bottom core structure 330, center core post structure 315, and sample 320, as shown in FIG. 3B.

### Example Embodiments of Tool Designs for SPS Systems

According to some embodiments, for low scale production, tall tools can be utilized to allow for sufficient physical space to compress parts at room temperature. In particular, when tooling dies are loaded with raw material, the raw material has a tap density roughly 3-5 times taller than the final part after it has been densified. When raw material is loaded, it is “fluffed up” (tapped density). In order to fit the raw material in the die, the height of the die should be tall enough to contain all the raw material prior to being compressed to a more compact shape. The part will fully compress and densify at the maximum set temperature in the SPS machine. For example: When loading raw material into a die, the tapped density of the raw material might be five times taller than the final density of the desired part prior to compressing.

According to some embodiments, for high production output, two example embodiments of methods of loading a modified tool are now described. For simple part designs, a short die, such as carbon fiber reinforced carbon, can be modified with an inexpensive, but strong material, such as aluminum. The inexpensive material acts as a funnel to load the raw material and compress the part to its maximum compressibility at room temperature. The top inexpensive mold is then removed, and you are left with a short-compressed carbon fiber reinforced carbon die. This allows you to stack significantly more dies in an SPS machine for a higher output per operating run. According to other embodiments, another example embodiment of a method is to have a top and bottom inexpensive die material such aluminum for compressing at room temperature. Advantages of a top and inexpensive die includes the ability to add complex shapes such as ventilation in a brake rotor for evenly distributed shapes.

### Example Embodiments of Methods for Manufacturing Ceramic Composites

Example embodiments of methods for manufacturing ceramic composites, such as carbon fiber reinforced ceramic composites, will now be described.

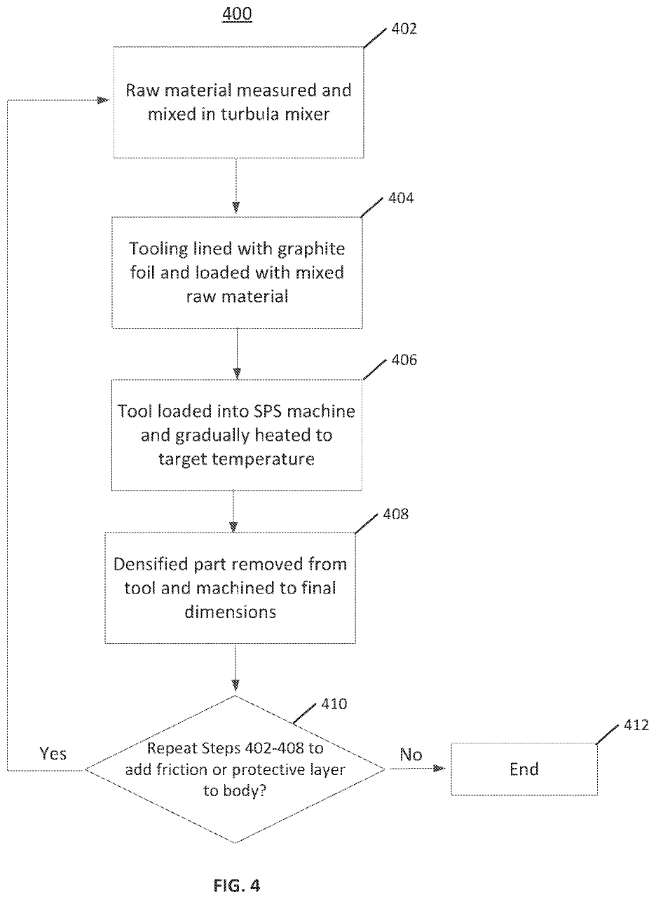

FIG. 4 is a flow diagram depicting an example embodiment of a method 400 for manufacturing ceramic composites, such as carbon fiber reinforced ceramic composites.

At Step 402, raw materials are first weighed out to their respective ratios for the target density and volume required to fill the cavity of the tooling die in production. Dry powders may be used as well as wet slurries that can be burned off. A prepared slurry is favored for discontinuous fiber matrices such as fabric, 3D printed, or one continuous strand through the matrix. Additives, or materials of less than 5% overall content of the formula, such as Aluminum, B4C, and Carbon Black are mixed in a tumble miller machine to create Al3BC3 (Aluminum, Boron Carbide, and Carbon Black). Tungsten carbide ball mills are used to smash the materials together to form the final material. Primary materials, or raw materials with larger than 5% overall content of the formula are then mixed in powder form first in a turbula mixer for a first predetermined duration. In some embodiments, the primary materials are mixed for a first predetermined duration of ten minutes in a forward direction and ten minutes in the reverse direction. Those of skill in the art will recognize that other first predetermined durations can be utilized, and are fully within the scope of the present disclosure. According to another aspect of the embodiments, a turbula mixer moves in the x-, y-, and z-axis to mix materials in various speeds. The advantage is creating a zero-gravity atmosphere that allows materials with a low and high density to homogenously mix in a short period. Once mixed, carbon fiber is added and mixed in a second predetermined duration. According to some embodiments, the second predetermined duration can comprise a time of two to four minutes in a forward motion, two to four minutes in a reverse motion, and at a relatively slower speed of 10%-15% (instead of 18%-30% machine speed) to ensure fibers do not clump.

At Step 404, after materials are mixed, they are loaded into the tooling for pre-compression, which can be the maximum amount a tool can be compressed with raw material at room temperature. In some embodiments, carbon fiber should be pitch based having a thermal conductivity from 100 w/mk to 800 w/mk. In some embodiments, high modulus PAN based carbon fibers as well as medium modulus pyrolytic carbon coated carbon fibers may also be used. According to some embodiments, carbon fibers can be continuous or short discontinuous, and/or (chopped) between ⅛″ to 2″ in length. According to some embodiments, raw powders should be 1-3 microns in size, or can be up to 100 microns in size.

According to another aspect of some embodiments, carbon fiber volume can range from 40%-60% volume of entire matrix. In some embodiments, SiC can range from 34% to 70% of the entire matrix volume. In some embodiments, ZrB2 can be between 3% to 25%. In some embodiments, additives such as Al3BC3, HfB2, ZrC, Al2O3, Y2O3, TaB2, B4C, TiB2, MgO, nitrides and/or different rare earth oxides or others can be 1%-3% in maximum content. In some embodiments, powders should be of 99%, or greater in purity.

At Step 406, once production tooling, which can be stacked or unstacked, is loaded into the SPS machine, production may begin. Low level compression (i.e., where the ram is compressing the tooling dies) is applied to the SPS machine. In some embodiments, the compression can be within a range of 5 mPa to 20 mPa. In another aspect of some embodiments, the temperature during low level compression can range from room temperature to 800-900 C, with a ramp up rate of 5 C/min to 50 C/min, depending on the desired speed of heating up large parts. Those of skill in the art will appreciate that the desired speed of heating up parts is related to how quickly a material can be heated tooling die without damaging it due to thermal stress shock and thermal expansion. In addition, higher ramp up rates of smaller parts can be up to 200 C per min. In many embodiments, throughout the entire process, an inert atmosphere is used to prevent oxidation of materials at high temperatures. According to some embodiments, this gas can be argon gas, nitrogen gas, and/or a vacuum around 1.00 E-3 Torr or 1.00 E-2 Torr.

According to another aspect of some embodiments, once the part has reached 800-900 C, additional pressure between 40 and 50 mPa is applied. The part continues to heat up to desired maximum temperature, such as a temperature between 1900 C to 2000 C. Ramp up rate may be slowed down if Ram temperature is overheating. (The ram is attached to the electrode. Even though its responsible for heating up tooling dies and raw material, the electrode only has a maximum temperature of 600 C. It is constantly cooled by flowing chilled water that is constantly recirculating through a chiller. If the thermal radiation of a tooling die is too great and heats up the ram faster then it can cool, the ram will shut down as an emergency shutoff.) Once desired temperature is reach, that temperature can be held for ten minutes for smaller parts, and up to one hour for larger parts (it takes significantly less time to densify a smaller part because of its actual size vs a larger part), or when the ram stops moving under pressure. This metric provides information on how the part is compressing and densifying in real time.

After the hold time is complete, the SPS current is shut off or reduced using a controlled cooling rate to prevent any thermal shock to the raw material that has densified. Ideal cooling rates range from 10 C/min to 150 C/min. It will depend on how large your part is and how sensitive it reacts to thermal shock. Faster is more desirable in order to improve production times. The desired speed of heating up the parts is related to how quickly one can heat a material and tooling die without damaging it due to thermal stress shock and thermal expansion.

Once the part has been cooled off, at Step 408, the densified part is removed and demolded. The part is than machined to finish to its final dimensions. According to some embodiments, once the part has been densified and machined, it can be placed back in the SPS machine under the identical conditions to bond another friction layer to it, as shown at Step 410. According to some embodiments, the fiber content of friction layer should be low to prevent oxidation on the surface. For example, according to some embodiments, a low carbon fiber is typically anything that is 30% or less of the entire matrix—a higher percentage has a larger impact on mechanical properties. In addition, higher contents of ZrB2 and SiC may be used for oxidation protection.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated otherwise or logically implausible. The embodiments described herein are restated and expanded upon in the following paragraphs without explicit reference to the figures.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer readable media, then that memory, storage, and/or computer readable media are non-transitory. Accordingly, to the extent that memory, storage, and/or computer readable media are covered by one or more claims, then that memory, storage, and/or computer readable media is only non-transitory.

In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

The subject matter described herein and in the accompanying figures is done so with sufficient detail and clarity to permit the inclusion of claims, at any time, in means-plus-function format pursuant to 35 U.S.C. section 112, part (f). However, a claim is to be interpreted as invoking this means-plus-function format only if the phrase “means for” is explicitly recited in that claim.

Aspects of the invention are set out in the independent claims and preferred features are set out in the dependent claims. The preferred features of the dependent claims may be provided in combination in a single embodiment and preferred features of one aspect may be provided in conjunction with other aspects.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

While the embodiments are susceptible to various modifications and alternative forms, specific examples thereof have been shown in the drawings and are herein described in detail. These embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the scope of the claims by features, functions, steps, or elements that are not within that scope.

1. A method for manufacturing a ceramic composite, the method comprising:
(a) measuring a plurality of raw materials to a predetermined ratio according to a target density and a target volume, and mixing the plurality of raw materials in a mixer;
(b) loading the mixed plurality of raw materials into a tooling;
(c) loading the tooling into a spark plasma sintering machine and heating the spark plasma sintering machine to a target temperature by conducting electricity through a mold;
(d) removing and demolding a densified part formed from the mixed plurality of raw materials; and
(e) machining the densified part according to a plurality of final dimensions.

2. The method of claim 1, wherein the mixer is a turbula mixer.

3. The method of claim 1, further comprising:
after loading the tooling into the spark plasma sintering machine, applying a low level compression to the plurality of raw materials.

4. The method of claim 3, wherein the low level compression is within a range of 5 mPa to 20 mPa.

5. The method of claim 3, further comprising:
increasing the temperature of the spark plasma sintering machine while applying the low level compression to the plurality of raw materials.

6. The method of claim 1, further comprising:
introducing a volume of inert gas into the spark plasma sintering machine.

7. The method of claim 6, wherein the inert gas is one of argon or nitrogen.

8. The method of claim 1, further comprising:
after heating the spark plasma sintering machine to the target temperature, cooling the spark plasma sintering machine and the tooling;

9. The method of claim 8, wherein cooling the spark plasma sintering machine comprises utilizing a controlled cooling rate to prevent thermal shock to the densified part.

10. The method of claim 1, further comprising:
after loading the plurality of raw materials into the tooling, applying a predetermined amount of pressure to the plurality of raw materials at room temperature.

11. The method of claim 1, wherein the plurality of raw materials comprises 40% to 60% carbon fiber by volume.

12. The method of claim 3, further comprising:
applying additional pressure to the spark plasma sintering machine after the target temperature is reached.

13. The method of claim 1, wherein the target temperature is between 1,900 C to 2,000 C.

14. The method of claim 1, further comprising:
placing the densified part in the spark plasma sintering machine and repeating one or more of steps (a) to (e) to create a friction layer on the densified part.
